(19) United States
(12) Patent Application Publication
(10) Pub. No.: US 2006/0004475 A1
(43) Pub. Date: Jan. 5, 2006

(54) Incrementally accruing product and component quality and tracking data in the manufacturing of devices

(75) Inventors: Paul S. Brackett, Cary, NC (US); David N. Cox, Raleigh, NC (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignees: ABB Inc.; ABB Research Ltd

(21) Appl. No.: 10/882,495

(22) Filed: Jul. 1, 2004

(51) Int. Cl. G06F 19/00

(52) U.S. Cl. 700/108; 700/115

(57) ABSTRACT

The compilation of product and component quality and tracking data for a manufactured device is facilitated. Software modules are provided that collect and transmit data regarding components, products, assembly, and testing to a central database for compilation, storage, and maintenance. A graphical user interface may be provided to assist a user in collecting data. Each module desirably collects one or more pieces of information at various stages during the product manufacturing. Devices such as bar code readers, force gauge meters, etc. can have their “readout” values captured seamlessly and automatically to update the electronic model (stored information) of the product being manufactured. This allows for additional and more accurate quality data to be collected without additional time or effort during manufacturing.

### FIELD OF THE INVENTION

The present invention relates in general to the field of data collection and storage. More particularly, the present invention relates to gathering and tracking discrete quality data.

### BACKGROUND OF THE INVENTION

A typical company may have multiple factories worldwide that design and manufacture devices such as medium voltage circuit breaker products and/or components. Additionally, such a company may buy component parts from many third party suppliers worldwide, which are used in the final manufactured devices.

During manufacture and assembly of such devices, information pertaining to the quality of the devices and products and their components parts is generated. This information is generated in various stages of the manufacturing process, by various machines and devices. The information is typically manually collected, using pen and paper for example, and set aside until after the manufacturing process is complete. After the devices and products are manufactured, then the information pertaining to their quality, and the quality of their components, is compiled into a database (e.g., by keypunching) and is archived and/or distributed with the devices and products. However, this data collection and manual entry into a database is a laborious and time-consuming task, and is prone to errors.

When a product that has been delivered to a customer encounters a problem, the manufacturing factory must troubleshoot the problem, to determine the root cause of the failure. Once a determination has been made, it is often required that the manufacturer also determine whether or not other delivered products have the same components, and possible quality issues. If so, these other products will require recall and/or some preventive maintenance. Because of the manual “pen and paper” method of collecting quality data, it is subject to unnecessary human error and often slows down the manufacturing process. Therefore, not all data necessary to determine the root cause is collected, and problems sometimes go unsolved.

It is thus desirable to facilitate the compilation of product and component quality and tracking data, as well as to improve product and component traceability, and to overcome the shortcomings of the prior art.

### SUMMARY OF THE INVENTION

The present invention is directed to facilitating the compilation of product and component quality and tracking data for assembled devices. Software modules are provided that collect and transmit data regarding components, products, assembly, and testing to a central database for compilation, storage, and maintenance.

An exemplary embodiment is directed to maintaining information during the manufacturing of a device, and comprises receiving component information about at least one component of the device; storing the component information in a storage device; receiving component test information; storing the component test information in the storage device; receiving device assembly information; storing the assembly information in the storage device; receiving device test information; and storing the device test information in the storage device.

According to aspects of the invention, the storage device comprises a central database, and/or an object data table. An object data table may comprise an associated object corresponding to each component, each object comprising a pointer to a property list of the object, each property list of the object pointing to a property of the object.

According to additional aspects of the invention, data pertaining to the components of the device being manufactured or being tested may be downloaded from a remote storage device, residing on a network, such as an internet or intranet website.

The foregoing and other aspects of the present invention will become apparent from the following detailed description of the invention when considered in conjunction with the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary system in accordance with the present invention;

FIG. 2 is a flow chart of an exemplary method of collecting and storing information in accordance with the present invention; and

FIG. 3 is a block diagram of another exemplary system in accordance with the present invention.

### DETAILED DESCRIPTION OF ILLUSTRATIVE EMBODIMENTS

Each component that becomes part of a final product unit has specific quality information associated with it. Some of this information, such as manufacturers' test reports, comes from the supplier on paper, or in electronic format such as XLS spreadsheets or ASCII files. Other information is simply known, but not recorded anywhere specifically, such as the assembler's name/initials and time of assembly. Moreover, information may be printed on the side of the component. Additional information is generated during assembly of the product. Still further information is gathered during product testing, by using other testing devices to do additional tests, before, during, or after assembling the component into the product. The present invention collects and centrally stores this information (e.g., as records or files in a database) during product manufacturing.

According to aspects of the present invention, software modules collect information and store the information into a central database. A graphical user interface may be provided to assist a user in collecting data. Each module desirably collects one or more pieces of information at various stages during the product manufacturing. Devices such as bar code readers, force gauge meters, etc. can have their “readout” values captured seamlessly and automatically to update the electronic model (stored information) of the product being manufactured. This allows for additional and more accurate quality data to be collected without additional time or effort during manufacturing.

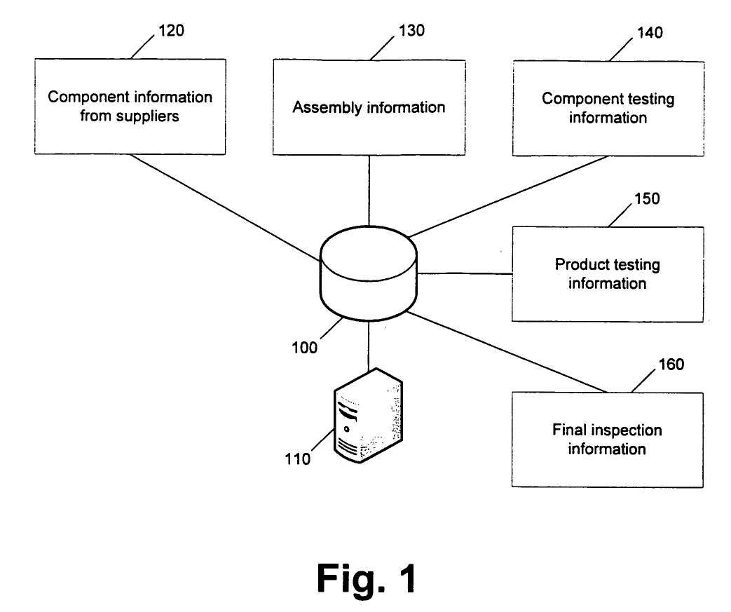

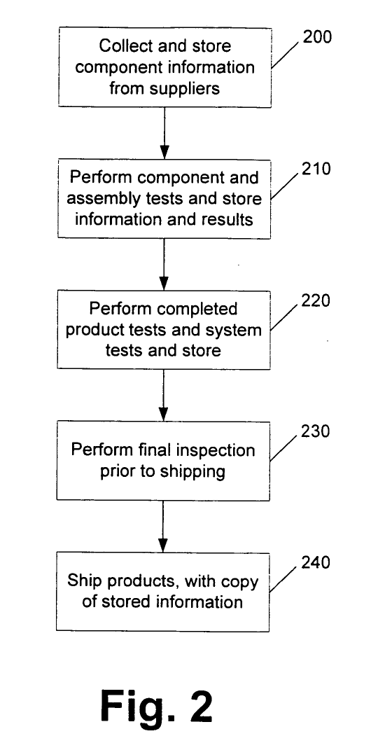

FIG. 1 is a block diagram of an exemplary system and FIG. 2 is a flow chart of an exemplary method of collecting and storing information, in accordance with the present invention. A central database 100 is coupled to a server 110 and various exemplary software modules 120-160, via a conventional wired or wireless network, for example. The software modules collect information during various phases of product manufacturing. An exemplary module 120 collects component information from the various suppliers (step 200). This component information is provided to the database 100 where it is stored in an appropriate file and/or format, as described in further detail herein.

After having received the component parts that will make up the manufactured product, information is collected during assembly of the product by assembly information module(s) 130 (step 210). The components may be tested during assembly, and the results of the testing are collected by component testing information module(s) 140. After the product has been manufactured from the various components, the product is tested, and the results of the testing is collected by product testing information module(s) 150 (step 220). Each of the modules 130, 140, 150 provides the collected information to the database 100. The database collates or otherwise organizes or formats the data and stores the data.

After the product has been tested, it receives final inspection prior to shipment to a customer (step 230). Final inspection module(s) 160 collects final inspection data and provides the data to the database 100, where it is appropriately stored. The product may then be shipped (step 240), either with or without a copy of the information that was collected during assembly (i.e., during steps 200-230).

In order to accommodate many different types of products and components, and allow introduction of new data elements, an object data table is desirably used that is not a typical database “row and column” data format. Preferably, each object has a pointer to one or more “Property Lists” which in turn point to one or more “Properties” of the object.

For example, an exemplary “Item” table in a database or storage device desirably comprises:

| | |
|---|---|
| ItemID | unique record id for this object; |
| ItemNumber | the serial number of the object; |
| ItemType | telling whether this is a ‘pole’, ‘actuator, etc., |
| | for example; |
| JobID | pointing back to the manufacturing, |
| | engineering, sales info, for example; |
| ParentID | pointing to the parent object; |
| CreateDate | date item was created in the system; and |
| ItemStatus | containing the current work in process status. |

An exemplary “Property List” table in a database or storage device desirably comprises:

An exemplary “Property List” table in a database
or storage device desirably comprises:

| | |
|---|---|
| ID | unique record id for this list; |
| Name | name of the list (such as “Test Results” or |
| | “Field Info”); and |
| ItemID | pointer to the item this list belongs to. |

An exemplary “Property” table in a database
or storage device desirably comprises:

| | |
|---|---|
| ID | unique record id for this property; |
| PropertyListID | parent list identifier; |
| Name | name of the property (“Open Time”, for example); |
| Value | The value contained for that property (“10 ms”, |
| | for example); |
| CreateDate | date/time that the object was created; |
| ModifyDate | date/time that the property was last accessed; and |
| Who | person last changing a property value. |

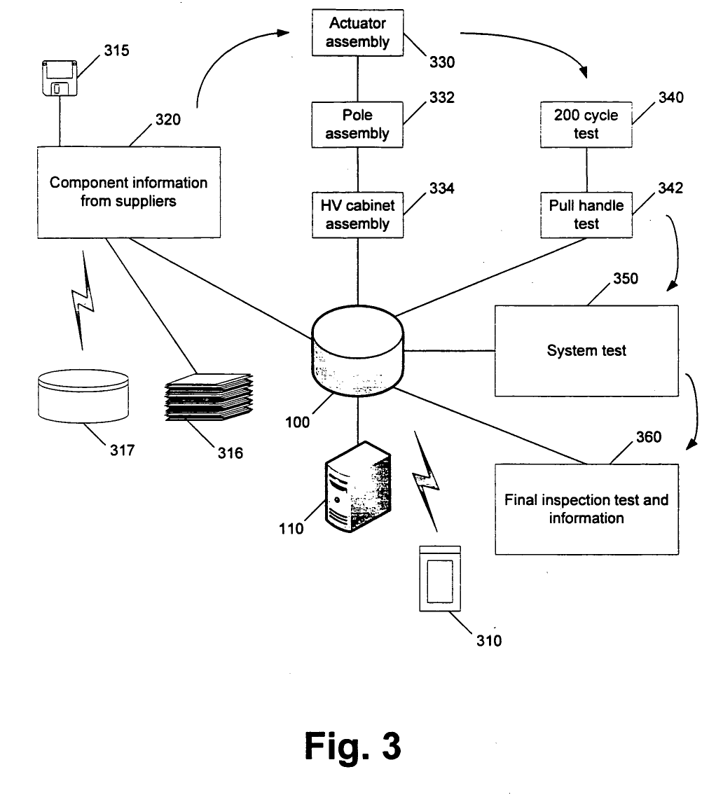

An embodiment of the present invention is used with the manufacture of medium voltage circuit breaker products. A medium voltage circuit breaker is considered to be a circuit breaker, recloser, or switch in the range of about 1 kV to about 50 kV range. FIG. 3 is a block diagram of an exemplary system of data gathering during the manufacture of a product, such as a medium voltage circuit breaker product, in accordance with the present invention. As in FIG. 1, a central database 100 is coupled to a server 110. The central database is also coupled to various software modules 320-360. The software modules may be resident on a personal computer, a handheld computer, or a scanner 310, for example, or any other computing device that is in electrical communication with the server 110 and database 100.

The component information from suppliers is collected by module(s) 320 and provided to the database 100. This data could be provided in electronic form (e.g., on a diskette 315 accompanying the component) and electronically transferred to the module(s) 320. Alternately, the data could be provided in written or printed form 316, in which case the data would be entered by hand (e.g., via a scanner 310) or by conventional optical character recognition techniques. Moreover, the data could reside on a website (e.g., the supplier's or manufacturer's website) or other storage 317 maintained by the supplier or manufacturer, and could be downloaded upon entry of a component code or other information related to the component (e.g., the component's serial number or bar code identifier).

During subsequent assembly, various modules 330-334 collect information and provide it to the central database 100. For example, during actuator assembly, an actuator assembly module 330 collects relevant information related to the actuator assembly, such as magnetic force, and provides the information to the database 100. Similarly, for example, during pole assembly, a pole assembly module 332 collects relevant information related to the pole assembly, such as open/close timing, and provides the information to the database 100. During HV cabinet assembly, an HV cabinet assembly module 334 collects information related to the HV assembly, such as handle force and contact hardening cycles, and provides the information to the database 100. For example, the scanner 310 can be used to scan the serial number of the part, component, or completed or partially completed product, and pertinent information could then be supplied to the database 100 (either directly or via the server 110, for example).

With respect to pole assembly, for example, a pole may be retrieved from inventory and have its serial number scanned into a database or other storage. Additional information, such as that set forth above with respect to the Item, Property List, and Property may be stored as well. Such information may include part number, date, operator identifier, and time. The pole is assembled into the actuator and an HV cabinet. At this point, information such as work order status, disposition, and defect information may be stored.

Components may be tested during manufacturing, and desirably this information is provided to the database 100. For example, during the manufacture of medium voltage circuit breaker products, a 200 cycle test, and a pull handle test may be performed. The results of the 200 cycle test are provided via a 200 cycle test information module 340 to the database 100, and the results of the pull handle test are provided via a pull handle test information module 342 to the database 100. Such tests can be programmed so that the results and other pertinent information is directly provided to the database 100, without further user interaction. Alternately, for example, the results and other information could be entered into a scanner 310 which then provides it to the database 100 for organization and storage. Such data collection will eliminate keypunch errors, data corruption, and other general data collection problems.

After the device (e.g., medium voltage circuit breaker) has been manufactured, it is tested and the test results and other pertinent information are collected by a system test module or modules 350 and provided to the database 100 for storage. Exemplary tests include ISD interface test, contact resistance check, oscilloscope test, PCD delta voltage test, and wire HI-POT test. Similar to the component testing, the results of the finished product tests are preferably directly provided to the database 100, without further user interaction. Alternately, for example, the test results and other information could be entered into a scanner 310 which then provides it to the database 100 for organization and storage.

Prior to shipping the finished product to a customer, there may be a final inspection test. The results of the final inspection test are provided to a final inspection test information module 360 which transmits the information to the database. As with the above described test modules, the test information module 360 can receive the information either directly from the test equipment, or entered via a scanner 310 or other user input device, for example.

At each stage of assembly and testing, an electronic “object” is desirably created that mirrors the physical component. The collected data is attached to each object, and tests are performed to see that the data is within acceptable ranges for the final product to function properly. Components may be identified by bar code scanning of their serial numbers, for example. If a component is rejected, the electronic object representing that component desirably has defect information attached to it, and the physical object is removed. The electronic object record is retained because sometimes components may be fixed and reused. It is desirable that the original data is retained in case of future product failure.

At this point, the database 100 has a complete set of information pertaining to the product, including component information, assembly information, and testing information. The information can be provided to the customer with delivery of the product, or maintained in storage for future use, analysis, and/or distribution. Thus, a single source of product information can be made available to all users of the system, and passed back to suppliers and on to customers. Data sharing between suppliers, manufacturers, and customers is thereby enhanced.

Thus, in accordance with the present invention, component and product quality data and information can be electronically collected, monitored, and maintained during the assembly and testing stages. Problems with components, suppliers, quality, and products can be recognized and analyzed earlier. The capture of component data from multiple suppliers provides for deeper, more accurate, root cause analysis.

Desirably, a single software module can be implemented that incorporates the various assembly and testing devices. In this way, multiple different assembly and test devices of data can be interfaced to the system, without requiring new or different software modules for every device. Thus, integrating new test equipment would be accomplished without the need for development of a new software module.

Although FIG. 3 has been described with respect to medium voltage circuit breakers, it is contemplated that the manufacture of other items, such as power transformers, distribution transformers, etc. can implement aspects of the present invention.

The invention may be embodied in the form of appropriate computer software, or in the form of appropriate hardware or a combination of appropriate hardware and software without departing from the spirit and scope of the present invention. Further details regarding such hardware and/or software should be apparent to the relevant general public. Accordingly, further descriptions of such hardware and/or software herein are not believed to be necessary.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed:

1. A method of maintaining information during manufacturing of a device comprising components, comprising:
receiving component information about at least one component of the device;
storing the component information in a storage device;
receiving component test information;
storing the component test information in the storage device;
receiving device assembly information;
storing the assembly information in the storage device;
receiving device test information; and
storing the device test information in the storage device.

2. The method of claim 1, wherein the storage device comprises a central database.

3. The method of claim 1, wherein the storage device comprises an object data table.

4. The method of claim 3, wherein the object data table comprises an associated object corresponding to each component, each object comprising a pointer to a property list of the object, each property list of the object pointing to a property of the object.

5. The method of claim 1, wherein at least one of the component information, component test information, assembly information, and device test information is received via a user interface.

6. The method of claim 1, wherein receiving the component test information comprises testing the component and generating component test information.

7. The method of claim 1, wherein receiving the device assembly information comprises assembling the device using the component and generating assembly information.

8. The method of claim 1, wherein receiving the device test information comprises testing the device and generating device test information.

9. The method of claim 1, further comprising formatting the component information, component test information, assembly information, and device test information.

10. The method of claim 1, receiving the component information comprises downloading data from a website.

11. A computer readable medium having computer-executable instructions for performing the steps recited in claim 1.

12. A computer-readable medium having computer-executable modules comprising:
a storage module for storing component information about a component, component test information, device assembly information about a device, and device test information; and
a user interface module for receiving at least one of the component information, component test information, assembly information, and device test information.

13. The computer-readable medium of claim 12, wherein the storage module comprises an object data table.

14. The computer-readable medium of claim 13, wherein the object data table comprises an associated object corresponding to each component of a plurality of components, each object comprising a pointer to a property list of the object, each property list of the object pointing to a property of the object.

15. The computer-readable medium of claim 12, further comprising a module for testing the component and generating component test information.

16. The computer-readable medium of claim 12, further comprising a module for assembling the device using the component and generating assembly information.

17. The computer-readable medium of claim 12, further comprising a module for testing the device and generating device test information.

18. The computer-readable medium of claim 12, wherein the storage module formats the component information, component test information, assembly information, and device test information.

19. The computer-readable medium of claim 12, further comprising a module for downloading data from a website.

20. A computer-readable medium having stored thereon a data structure, comprising:
a first data field containing component information about at least one component of a device;
a second data field containing component test information;
a third data field containing device assembly information; and
a fourth data field containing device test information.

21. The computer-readable medium of claim 20, wherein the first, second, third, and fourth data fields are comprised within an object data table.

22. The computer-readable medium of claim 21, wherein the object data table comprises an associated object corresponding to each component, each object comprising a pointer to a property list of the object, each property list of the object pointing to a property of the object.

23. A system for maintaining information during manufacturing of a device comprising components, comprising:
a storage device for storing component information about a component, component test information, device assembly information about a device, and device test information; and
a user interface device for receiving at least one of the component information, component test information, assembly information, and device test information; and
a computing device in electrical communication with the storage device and the user interface.

24. The system of claim 23, wherein the storage device comprises a central database.

25. The system of claim 23, wherein the storage device comprises an object data table.

26. The system of claim 25, wherein the object data table comprises an associated object corresponding to each component, each object comprising a pointer to a property list of the object, each property list of the object pointing to a property of the object.

27. The system of claim 23, further comprising a tester for testing the component and generating component test information.

28. The system of claim 23, further comprising an assembler for assembling the device using the component and generating assembly information.

29. The system of claim 23, further comprising a tester for testing the device and generating device test information.

30. The system of claim 23, wherein the computing device is adapted to format the component information, component test information, assembly information, and device test information.

31. The system of claim 23, wherein the computing device is adapted to receive the component information from a website.
